(19) United States
(12) Patent Application Publication
(10) Pub. No.: US 2026/0202336 A1
(43) Pub. Date: Jul. 16, 2026

(54) CONFOCAL LASER SPECTROGRAPH FOR CAPILLARY ELECTROPHORESIS

(71) Applicant: Promega Corporation, Madison, WI (US)

(72) Inventors: Sergey Lazarev, Madison, WI (US); Cristopher Cowan, Madison, WI (US)

(21) Appl. No.: 19/448,392

(22) Filed: Jan. 14, 2026

Related U.S. Application Data
(60) Provisional application No. 63/745,382, filed on Jan. 15, 2025.

(51) Int. Cl. G01N 21/64

(52) U.S. Cl. CPC G01N 21/645; G01N 2021/6463; G01N 2201/105

(57) ABSTRACT

A confocal spectrograph system comprising a camera, a laser source that generates a laser light, an optical scanner that receives the laser light and outputs a scanner output light, and a lens oriented along an optical axis. The lens receives the scanner output light. The system further includes a beam splitter positioned on the optical axis, and the beam splitter reflects the scanner output light toward the lens. The system further includes a sample assembly positioned on the optical axis, and a fluorescence light from the sample assembly passes through the lens and the beam splitter. A diffraction grating that receives the fluorescence light passing through the beam splitter and directs the fluorescence light to the camera.

### CROSS-REFERENCE TO RELATED APPLICATION

This application claims the benefit of U.S. Provisional Application No. 63/745,382, filed Jan. 15, 2025, which is incorporated herein by reference in its entirety.

TECHNICAL FIELD The present disclosure relates to systems, devices, assemblies, and methods for spectrographs.

### BACKGROUND

Fluorescence can be used to enable detection technology for many fields including fundamental research, analytical chemistry, separation science, biochemical assay monitoring, and drug discovery. For example, the development of fluorescence-based, multi-capillary gel electrophoresis instruments enabled the completion of the human genome project ahead of schedule and ushered medical research into the era of personalized medicine.

In certain capillary electrophoresis (CE) systems, fluorescence detection is performed using lasers. A laser light source provides a focused beam with a relatively narrow spectral width (e.g., 1-5 nm for laser diodes or even less, e.g., 0.01-0.001 nm for gas lasers) and a relatively high photon density, thereby enabling high sensitivity measurements even when the area of excitation is relatively small (e.g., on the order of tens of micrometers).

Conventional spectrograph design can have restricted access of the excitation laser light to the capillaries containing the fluorescent-dye-labeled fragments, for example.

### SUMMARY

The disclosure provides, in one aspect, a system comprising a camera, a laser source that generates a laser light, an optical scanner that receives the laser light and outputs a scanner output light, and a lens oriented along an optical axis; wherein the lens receives the scanner output light. The system further comprises a beam splitter positioned on the optical axis; wherein the beam splitter reflects the scanner output light toward the lens; and a sample assembly positioned on the optical axis. A fluorescence light from the sample assembly passes through the lens and the beam splitter. The system further comprises a diffraction grating that receives the fluorescence light passing through the beam splitter and directs the fluorescence light to the camera.

In some embodiments, the lens focuses the scanner output light and collects the fluorescence light from the sample assembly to create a collinear beam of light.

In some embodiments, the optical scanner is a micro-electro-mechanical-system mirror.

In some embodiments, the optical scanner is a laser galvanometer.

In some embodiments, the optical scanner is configured for adjusting the scanner output light in two dimensions.

In some embodiments, the sample assembly includes a capillary array.

In some embodiments, the scanner output light is a line perpendicular to the capillary array.

In some embodiments, the system further comprises a slit positioned between the lens and the sample assembly.

In some embodiments, the beam splitter is angled with respect to the optical axis at an angle; wherein the angle is within a range of 35 degrees to 55 degrees.

In some embodiments, the diffraction grating is positioned on the optical axis.

In some embodiments, the lens is a first lens and the system further comprises a second lens positioned between the diffraction grating and the camera.

In some embodiments, the system further comprises a position feedback system including a sensing lens and a sensor.

In some embodiments, the beam splitter is positioned between the optical scanner and the sensing lens; and wherein a portion of the scanner output light passes through the beam splitter to the sensing lens; and wherein the sensor generates a signal based on the portion of the scanner output light.

In some embodiments, the system further comprises an electronic system including a processor for controlling operation of the optical scanner based on the signal from the sensor.

In some embodiments, the sensing lens and the sensor are aligned along a feedback axis; and wherein the feedback axis passes through the beam splitter.

In some embodiments, the system further comprises a first filter positioned on the optical axis between the beam splitter and the diffraction grating; and further comprising a second filter positioned between the diffraction grating and the camera.

In some embodiments, the first filter and the second filter are long-pass filters.

In some embodiments, the laser source generates laser light along a laser source axis that is parallel to the optical axis.

In some embodiments, the camera is oriented along a camera axis and the diffraction grating is positioned on the optical axis and positioned on the camera axis.

In some embodiments, the camera axis and the optical axis intersect at a diffraction angle; wherein the diffraction angle is within a range of 5 degrees to 55 degrees.

Other aspects of the disclosure will become apparent by consideration of the detailed description and accompanying drawings.

### DEFINITIONS

As used herein, the term “confocal” refers to an optical system having a common focus or image point.

As used herein, the terms “processor,” “central processing unit,” or “CPU” are used interchangeably and refer to a device that is able to read a program from a computer memory (e.g., ROM or other computer memory) and perform a set of steps according to the program. As used herein, the term “processor” (e.g., a microprocessor, a microcontroller, a processing unit, or other suitable programmable device) can include, among other things, a control unit, an arithmetic logic unit (“ALC”), and a plurality of registers and can be implemented using a known computer architecture (e.g., a modified Harvard architecture, a von Neumann architecture, etc.). In some embodiments, the processor is a microprocessor that can be configured to communicate in a stand-alone and/or a distributed environment and can be configured to communicate via wired or wireless communications with other processors, where such one or more processor can be configured to operate on one or more processor-controlled devices that can be similar or different devices.

As used herein, the term “memory” is any memory storage and is a non-transitory computer readable medium. The memory can include, for example, a program storage area and the data storage area. The program storage area and the data storage area can include combinations of different types of memory, such as a ROM, a RAM (e.g., DRAM, SDRAM, etc.), EEPROM, flash memory, a hard disk, a SD card, or other suitable magnetic, optical, physical, or electronic memory devices. The processor can be connected to the memory and execute software instructions that are capable of being stored in a RAM of the memory (e.g., during execution), a ROM of the memory (e.g., on a generally permanent bases), or another non-transitory computer readable medium such as another memory or a disc. In some embodiments, the memory includes one or more processor-readable and accessible memory elements and/or components that can be internal to the processor-controlled device, external to the processor-controlled device, and can be accessed via a wired or wireless network. Software included in the implementation of the methods disclosed herein can be stored in the memory. The software includes, for example, firmware, one or more applications, program data, filters, rules, one or more program modules, and other executable instructions. For example, the processor can be configured to retrieve from the memory and execute, among other things, instructions related to the processes and methods described herein.

As used herein, the term “computer readable medium” refers to any device or system for storing and providing information (e.g., data and instructions) to a computer processor.

Examples of computer readable media include, but are not limited to, DVDs, CDs, hard disk drives, magnetic tape, and servers for streaming media over networks, whether local or distant (e.g., cloud-based).

“About” and “approximately” are used to provide flexibility to a numerical range endpoint by providing a given value that may be “slightly above” or “slightly below” the endpoint without affecting the desired result.

The term “coupled,” as used herein, is defined as “connected,” although not necessarily directly, and not necessarily mechanically. The term coupled is to be understood to mean physically, magnetically, chemically, fluidly, electrically, or otherwise coupled, connected, or linked and does not exclude the presence of intermediate elements between the coupled elements absent specific contrary language.

As used herein, the term “in electronic communication” refers to electrical devices (e.g., computers, processors, etc.) that are configured to communicate with one another through direct or indirect signaling. Likewise, a computer configured to transmit (e.g., through cables, wires, infrared signals, telephone lines, airwaves, etc.) information to another computer or device, is in electronic communication with the other computer or device.

As used herein, the term “transmitting” refers to the movement of information (e.g., data) from one location to another (e.g., from one device to another) using any suitable means.

As used herein, the term “network” generally refers to any suitable electronic network including, but not limited to, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some embodiments, the network is a cellular network, such as, for example, a Global System for Mobile Communications (“GSM”) network, a General Packet Radio Service (“GPRS”) network, an Evolution-Data Optimized (“EV-DO”) network, an Enhanced Data Rates for GSM Evolution (“EDGE”) network, a 3GSM network, a 4GSM network, a 5G New Radio, a Digital Enhanced Cordless Telecommunications (“DECT”) network, a digital AMPS (“IS-136/TDMA”) network, or an Integrated Digital Enhanced Network (“iDEN”) network, etc.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an,” and “the” include plural references unless the context clearly dictates otherwise. The present disclosure also contemplates other embodiments “comprising,” “consisting of,” and “consisting essentially of” the embodiments or elements presented herein, whether explicitly set forth or not.

For the recitation of numeric ranges herein, each intervening number therebetween with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “top” and “bottom,” “front,” and “rear,” “inner,” and “outer,” “above,” “below,” “upper,” “lower,” “vertical,” “horizontal,” “upright,” and the like are used as words of convenience to provide reference points.

### BRIEF DESCRIPTION OF THE DRAWINGS

FIG. 1 is a perspective view of a confocal spectrograph.

FIG. 2 is a top view of the confocal spectrograph of FIG. 1.

FIG. 3 is a perspective view of a portion of the confocal spectrograph of FIG. 1 and a sample assembly with a capillary array.

FIG. 4 is a top view of an optical schematic of the confocal spectrograph of FIG. 1.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety.

The materials, methods, and examples disclosed herein are illustrative only and not intended to be limiting.

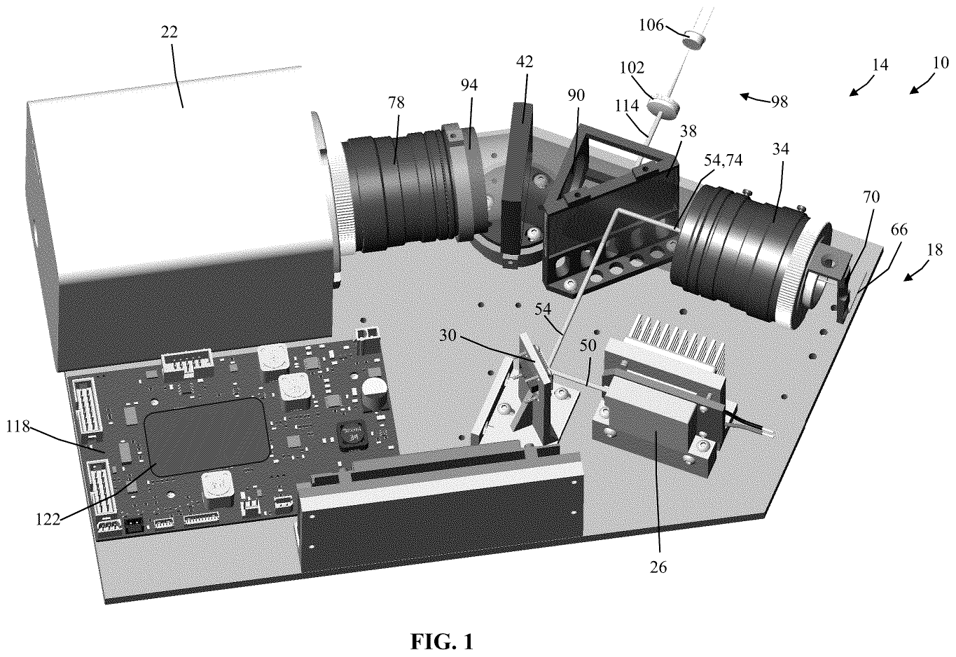

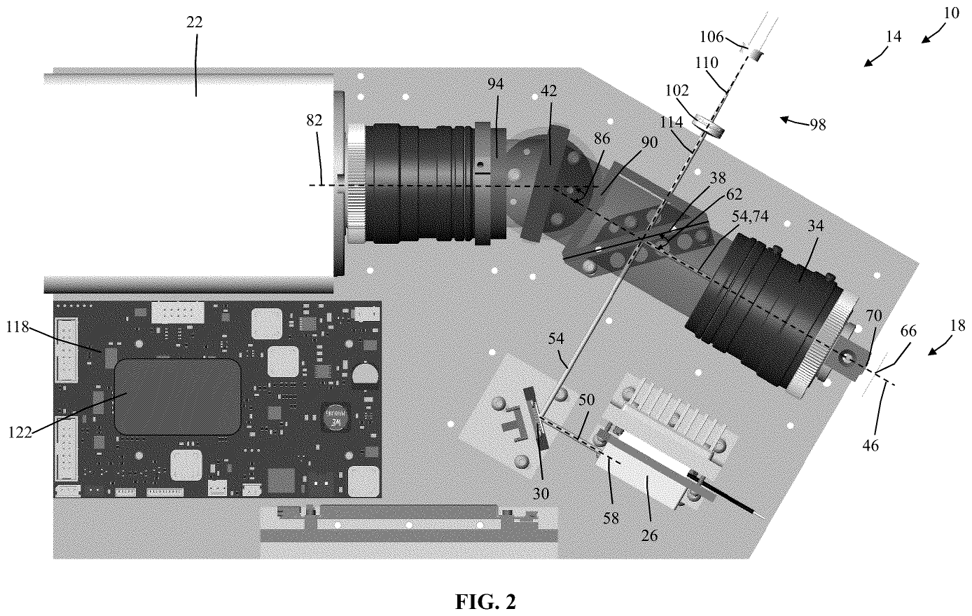

With reference to FIGS. 1 and 2, a system 10 is illustrated with a spectrograph 14 and a sample assembly 18. The spectrograph 14 includes a camera 22, a laser source 26, an optical scanner 30, a primary lens 34, a beam splitter 38, and a diffraction grating 42. As described in greater detail herein, the spectrograph 14 is a confocal spectrograph that includes a confocal optical path along an optical axis 46 that is configured to provide absolute coincidence of the excitation source beam and the emitted fluorescence signal from the sample assembly 18.

The laser source 26 generates a laser light 50, and the optical scanner 30 receives the laser light 50 and outputs a scanner output light 54. In the illustrated embodiment, the laser source 26 generates the laser light 50 along a laser source axis 58 that is initially parallel to the optical axis 46. In some embodiments, the laser source 26 includes a blue-green laser diode. In some embodiments, the laser light 50 includes wavelengths within a range of approximately 485 nm to approximately 495 nm or within a range of approximately 505 nm to approximately 520 nm. In some embodiments, the laser light 50 has a power within a range of approximately 10 mW to approximately 1000 mW. In some embodiments, the laser light 50 may have a beam divergence within a range of approximately 0.5 milliradians to approximately 5 milliradians.

In some embodiments, the optical scanner 30 is a micro-electro-mechanical-system (MEMS) mirror. In some embodiments, the optical scanner 30 is a laser galvanometer. In the illustrated embodiment, the optical scanner 30 is configured for adjusting the scanner output light 54 in two dimensions (e.g., in an X direction and a Y direction). In some embodiments, the scanner output light 54 is a laser line that is adjustable along two dimensions. By “line” it is understood that the line is only a line segment, and the entirety of the line does not exist at any instant. Instead, the laser beam still has a substantially circular or elliptical cross-sectional profile at any instant. But, because the beam is being moved over time, the movement of the beam is along the path of a line, and a registering camera observes not a single laser spot, but a solid line whereby all the capillaries are illuminated relatively equally during a single camera frame exposure. Similar laser-liner-generating systems are disclosed in U.S. Pat. No. 12,019,046 “Laser Illumination Techniques for Capillary Electrophoresis,” which is incorporated herein by reference in its entirety. In some embodiments, the scanning MEMS mirror works at resonant frequency and does not need driving electronics to suppress unwanted resonant oscillations.

With continued reference to FIGS. 1 and 2, the primary lens 34 is oriented along the optical axis 46 and receives the scanner output light 54 from the beam splitter 38. The beam splitter 38 reflects the scanner output light 54 from the optical scanner 30 toward the primary lens 34. In the illustrated embodiment, the beam splitter 38 is positioned on the optical axis 46.

The beam splitter 38 is angled with respect to the optical axis 46 at an angle 62. In some embodiments, the angle 62 is within a range of approximately 35 degrees to approximately 55 degrees. In some embodiments, the angle 62 is set to any suitable value depending on the optical layout.

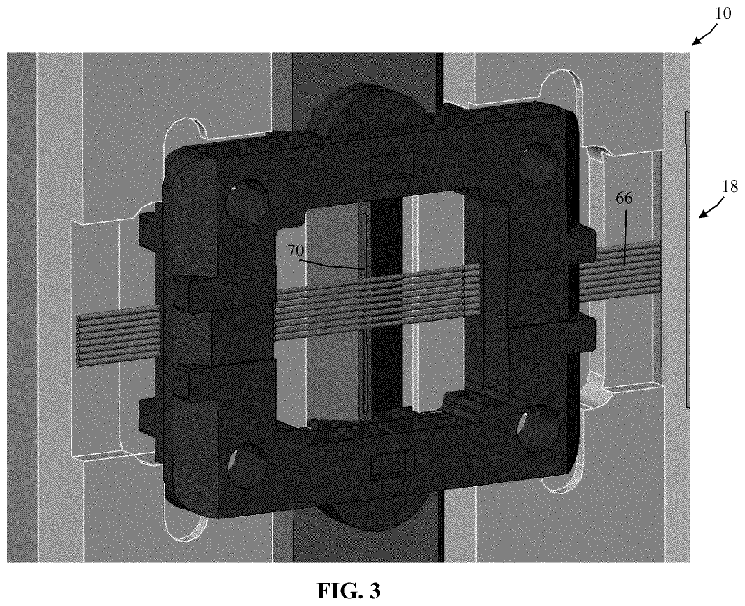

With reference to FIG. 3, the sample assembly 18 is positioned on the optical axis 46 and includes a capillary array 66. The capillary array 66 is a plurality of parallel capillaries in which the fluorescently labeled analytes are separated. In the illustrated embodiment, the scanner output light 54 is a line perpendicular to the capillary array 66. The system 10 further comprises a slit 70 positioned between the primary lens 34 and the sample assembly 18. The slit 70 is configured to block stray noise from the excitation source and off-angle emission from the excited fluorescent dyes. In some embodiments, the optical scanner 30 is a bidirectional XY scanning MEMS mirror that aligns the laser light onto the sample assembly 18 in the X direction and the Y direction. Advantageously, the optical scanner 30 allows precise aligning of the laser beam to excite the fluorescent dyes directly in front of the slit 70 while also scanning the beam to create a laser line across the capillary array 66. The system 10 advantageously provides improved access of the laser to the capillaries.

With continued reference to FIGS. 1 and 2, the scanner output light 54 excites the sample assembly 18, and a fluorescence light 74 is emitted from the sample assembly 50. In the illustrated embodiment, the fluorescence light 74 is emitted from fluorescent fragments in the capillary array 66. The fluorescence light 74 from the sample assembly 18 passes through the primary lens 34 and the beam splitter 38. Advantageously, the primary lens 34 focuses the scanner output light 54 onto the sample assembly 18 and collects the fluorescence light 74 from the sample assembly 18 to create a collinear beam of light. In other words, the primary lens 34 will focus the laser beam excitation source prior to reaching the capillary array, and the primary lens 34 will collect the emitted fluorescence light to create a collinear beam of light for separation by the diffraction grating 42.

With continued reference to FIGS. 1 and 2, the diffraction grating 42 is positioned on the optical axis 46 and receives the fluorescence light 74 passing through the beam splitter 38. The diffraction grating 42 directs the fluorescence light 74 to a secondary lens 78 and the camera 22. In the illustrated embodiment, the secondary lens 78 is positioned between the diffraction grating 42 and the camera 22. The secondary lens 78 is configured to collect the diffracted light and creates the spectral image on the camera 22. The camera 22 is oriented along a camera axis 82 and is configured to detect the emitted fluorescent signal from the fragments separated during capillary electrophoresis. The diffraction grating 42 is positioned on the optical axis 46 and positioned on the camera axis 82. The camera axis 82 and the optical axis 46 intersect at a diffraction angle 86. In some embodiments, the diffraction angle 86 is within a range of approximately 5 degrees to approximately 55 degrees. In some embodiments, the diffraction angle 86 is based on parameters of the diffraction grating 42.

With continued reference to FIGS. 1 and 2, the spectrograph 14 further comprises a first filter 90 positioned on the optical axis 46 between the beam splitter 38 and the diffraction grating 42. The spectrograph 14 further comprises a second filter 94 positioned on the camera axis 82 between the diffraction grating 42 and the camera 22. In some embodiments, the first filter 90 and the second filter 94 are long-pass filters to remove residual scattered excitation light while allowing the emitted fluorescent light to be transmitted toward the lens 78.

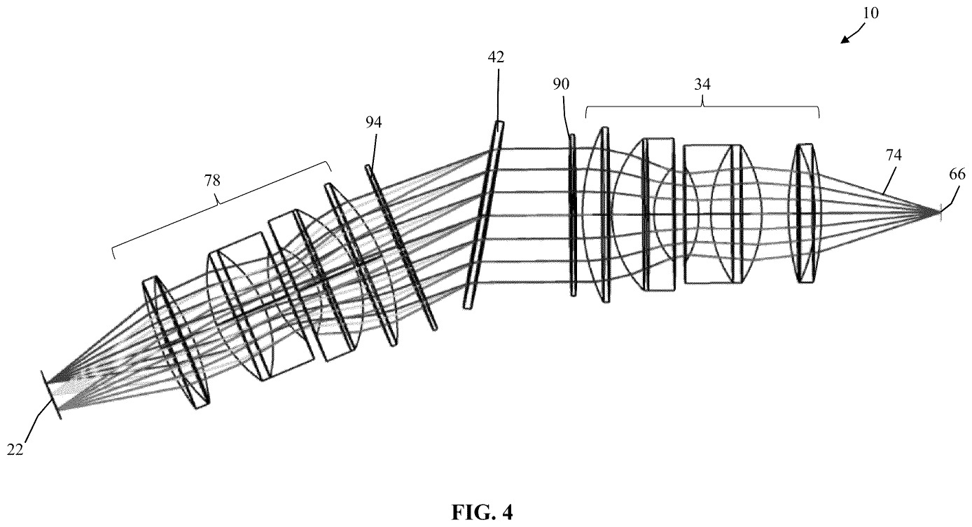

With reference to FIG. 4, the confocal optical design of the spectrograph 14 is illustrated. Advantageously, the confocal optical design reduces complexity and simplifies the optical configuration of the spectrograph 14 by combining the excitation and emission light into a single path. Such a combination provides absolute alignment of the optical system making excitation and emission processes optically identical, but in opposite directions. In the illustrated embodiment, the beam splitter 38 is a dichroic beam splitter configured to reflect the laser excitation source light towards the sample assembly 18 while allowing emitted fluorescence light to transmit through the beam splitter 38 toward the diffraction grating 42. Dichroic beam splitters allow differentiation of the excitation laser beam and emitted fluorescence light with very high efficiency. Confocal excitation uses the same optical lenses (e.g., the primary lens 34) for focusing the excitation beam and collecting emitted fluorescent light.

With continued reference to FIG. 4, in the illustrated embodiment, the diffraction grating 42 is configured to separate the emitted fluorescent light into component wavelengths that are detected by the camera 22. The optical system disclosed herein improves the amount of emitted fluorescence light available to be detected by the camera, potentially improving system sensitivity. The confocal optical design disclosed herein advantageously removes the necessity for separate optical excitation and emission paths that would need to be otherwise aligned.

With continued reference to FIGS. 1 and 2, the spectrograph 14 further comprises a position feedback system 98 including a sensing lens 102 and a sensor 106 aligned along a feedback axis 110. In the illustrated embodiment, the beam splitter 38 is positioned between the optical scanner 30 and the sensing lens 102. The feedback axis 110 passes through the beam splitter 38. A portion 114 of the scanner output light 54 passes through the beam splitter 38 to the sensing lens 102. In other words, the beam splitter 38 does not reflect all of the scanner output light 54 towards the primary lens 34 and some of the scanner output light (e.g., the portion 114) passes through the beam splitter 38 towards the sensing lens 102. The sensing lens 102 focuses residual laser beam coming through the beam splitter 38 onto the sensor 106. The portion 114 of the scanner output light 54 passing through the sensing lens 102 is incident on the sensor 106, and the sensor 106 generates a signal based on the portion 114 of the scanner output light 54.

The spectrograph 14 further comprises an electronic system 118 including a processor 122 for controlling operation of the optical scanner 30 based on the signal received from the sensor 106. In other words, the sensor 106 provides position feedback to the processor 122 for closed-loop control of the optical scanner 30. In some embodiments, the sensor 106 is a position sensor that generates an error signal to correct the laser beam positioning. In some embodiments, the processor 122 of the electronic system 118 also controls the laser source, thermal electric cooling, the optical scanner, sensor amplifiers, A/D converters, etc.

Various features and advantages are set forth in the following claims.

What is claimed is:

1. A system comprising:
a camera;
a laser source that generates a laser light;
an optical scanner that receives the laser light and outputs a scanner output light;
a lens oriented along an optical axis; wherein the lens receives the scanner output light;
a beam splitter positioned on the optical axis; wherein the beam splitter reflects the scanner output light toward the lens;
a sample assembly positioned on the optical axis;
wherein a fluorescence light from the sample assembly passes through the lens and the beam splitter; and
a diffraction grating that receives the fluorescence light passing through the beam splitter and directs the fluorescence light to the camera.

2. The system of claim 1, wherein the lens focuses the scanner output light and collects the fluorescence light from the sample assembly to create a collinear beam of light.

3. The system of claim 1, wherein the optical scanner is a micro-electro-mechanical-system mirror.

4. The system of claim 1, wherein the optical scanner is a laser galvanometer.

5. The system of claim 1, wherein the optical scanner is configured for adjusting the scanner output light in two dimensions.

6. The system of claim 1, wherein the sample assembly includes a capillary array.

7. The system of claim 6, wherein the scanner output light is a line perpendicular to the capillary array.

8. The system of claim 1, further comprising a slit positioned between the lens and the sample assembly.

9. The system of claim 1, wherein the beam splitter is angled with respect to the optical axis at an angle; wherein the angle is within a range of 35 degrees to 55 degrees.

10. The system of claim 1, wherein the diffraction grating is positioned on the optical axis.

11. The system of claim 1, wherein the lens is a first lens and the system further comprises a second lens positioned between the diffraction grating and the camera.

12. The system of claim 1, further comprising a position feedback system including a sensing lens and a sensor.

13. The system of claim 12, wherein the beam splitter is positioned between the optical scanner and the sensing lens; and wherein a portion of the scanner output light passes through the beam splitter to the sensing lens; and wherein the sensor generates a signal based on the portion of the scanner output light.

14. The system of claim 13, further comprising an electronic system including a processor for controlling operation of the optical scanner based on the signal from the sensor.

15. The system of claim 13, wherein the sensing lens and the sensor are aligned along a feedback axis; and wherein the feedback axis passes through the beam splitter.

16. The system of claim 1, further comprising a first filter positioned on the optical axis between the beam splitter and the diffraction grating; and further comprising a second filter positioned between the diffraction grating and the camera.

17. The system of claim 16, wherein the first filter and the second filter are long-pass filters.

18. The system of claim 1, wherein the laser source generates the laser light along a laser source axis that is parallel to the optical axis.

19. The system of claim 1, wherein the camera is oriented along a camera axis and the diffraction grating is positioned on the optical axis and positioned on the camera axis.

20. The system of claim 19, wherein the camera axis and the optical axis intersect at a diffraction angle; wherein the diffraction angle is within a range of 5 degrees to 55 degrees.
